(19) United States
(12) Patent Application Publication
(10) Pub. No.: US 2012/0296464 A1
(43) Pub. Date: Nov. 22, 2012

(54) PARALLEL INPUT/OUTPUT SIGNAL DISTRIBUTOR AND PARALLEL INPUT/OUTPUT SIGNAL DISTRIBUTION METHOD

(75) Inventor: Byoung Min Im, Yongin-si (KR)

(73) Assignee: Tokyo Electron Limited, Tokyo (JP)

(21) Appl. No.: 13/577,748

(22) PCT Filed: Feb. 15, 2010
(86) PCT No.: PCT/JP2010/052179

§ 371 Date: Aug. 8, 2012

(51) Int. Cl. G06F 19/00

(52) U.S. Cl. 700/117

(57) ABSTRACT

Provided is a parallel input/output signal distributor for distributing the contents of parallel input/output communication between a facility-side controller of a semiconductor manufacturing process automating facility and a semiconductor manufacturing device, said parallel input/output signal distributor comprising an input unit to which a parallel input/output signal containing the contents of parallel input/output communication between the facility-side controller and the semiconductor manufacturing device is inputted from a parallel input/output signal sensor end on the facility-side controller side, a first output unit which outputs the inputted parallel input/output signal to the facility-side controller, and a second output unit which outputs the inputted parallel input/output signal.

### TECHNICAL FIELD

The present invention relates to a parallel input/output signal distributor and a method for distributing a parallel input/output signal.

### BACKGROUND ART

In an automation system of a semiconductor manufacturing process, a monitoring system has been proposed in which a parallel input/output signal that performs a communication using a SEMI Equipment Communication Standard (SECS) protocol is stored as logging data and the automated manufacturing process is monitored based on the stored data.

Conventionally, when a problem occurs while performing a parallel input/output communication between a semiconductor manufacturing apparatus and a facility-side controller (e.g., a controller manipulated by an operator in a factory site where the semiconductor manufacturing apparatus is installed), the cause of the problem occurred on the parallel input/output communication has been investigated at the position of both systems by analyzing the parallel input/output communication logs which are logged in both systems of the semiconductor manufacturing apparatus and the facility-side controller.

In this case, it has been difficult to analyze the logging data objectively in the conventional system. As a result, in the related art, each of the systems analyzes the contents of the logging data at its own position and claims that its own system does not have a specific problem, the data transmission from its own system to a counterpart system is being normally performed, and thus, the problem occurs on the data transmission from the counterpart system to its own system. However, this kind of claim is close to an argument of a subjective opinion rather than an objective argument of the contents of the logging data at the position of each system.

In a parallel input/output communication between a semiconductor manufacturing apparatus 11 and a facility-side controller 12 in the conventional technologies, as illustrated in FIG. 1, the communication is performed between a parallel input/output sensor end 15 of the semiconductor manufacturing apparatus 11 side and a parallel input/output sensor end 16 of the facility-side controller 12 side, and signal data used in the communication is stored in each of the semiconductor manufacturing apparatus 11 side and the facility-side controller 12 side, as parallel input/output communication log data 13, 14.

In the conventional technologies, when a problem occurs during the parallel input/output communication, a parallel input/output communication log (e.g., a system log and a machine log) is obtained to be analyzed, and then, when a specific problem is not found on the log data, it needs to confirm whether or not the data are outputted directly to the parallel input/output sensor end 16 attached to the facility-side controller 12 side. Furthermore, when a specific problem is not found in the sensor end 16 as well, it is concluded that there is no specific problem on the parallel input/output communication at the facility-side controller 12 side, and then the same procedures are performed for a log at the semiconductor manufacturing apparatus 11 side. Furthermore, when a specific problem is not found at the semiconductor manufacturing apparatus 11 side as well, it is regarded as an unknown cause.

In these conventional technologies, there are many cases where it is interpreted that each of systems has no problem in finding a cause for a problem during the parallel input/output communication. In this case, it is difficult to clarify which system is responsible for an error of the parallel input/output communication, and it is inconvenient for an operator to view and confirm the history of the parallel input/output signal data. Also, when a long time elapses after the problem occurs, the log analysis operation itself may not be performed because the data itself would be lost. For this reason, an operator has to stand by at all times to confirm whether an error occurs at the semiconductor manufacturing apparatus, causing a physical burden and mental stresses to the operator.

### SUMMARY OF INVENTION

### Problems to be Solved by the Invention

The present invention has been made in considering the problems of the related art described above. One of the objects of the present invention is to clarify which system is responsible for an error that causes a problem by providing objective data when viewed by a third party, prevent the log from not capable of being analyzed because of the overwriting of the log data after a long time has elapsed in the facility-side controller side or the semiconductor manufacturing apparatus side, thereby reducing the physical tiredness and mental stresses of the operator who has to standby for a long time in the site to get ready for the occurrence of the problem.

### Means to Solve the Problems

To accomplish the above-mentioned object, a first exemplary embodiment of the present invention provides a parallel input/output signal distributor that distributes the contents of a parallel input/output communication between a semiconductor manufacturing apparatus and a facility-side controller of an automated facility of a semiconductor manufacturing process, the distributor including:

an input unit to which a parallel input/output signal including the contents of the parallel input/output communication between the facility-side controller and the semiconductor manufacturing apparatus is inputted from a parallel input/output signal sensor end of the facility-side controller side;

a first output unit configured to output the inputted parallel input/output signal to the facility-side controller; and

a second output unit configured to output the inputted parallel input/output signal.

To accomplish the above-mentioned object, a second exemplary embodiment of the present invention provides a parallel input/output signal distribution method for distributing the contents of the parallel input/output communication between a semiconductor manufacturing apparatus and a facility-side controller of an automated facility of a semiconductor manufacturing process using the apparatus as described above, the method including:

inputting a parallel input/output signal from a parallel input/output signal sensor end of the facility-side controller side to an input unit of the parallel input/output signal distributor;

outputting the inputted parallel input/output signal from a first output unit of the parallel input/output signal distributor to the facility-side controller; and

outputting the inputted parallel input/output signal from a second output unit of the parallel input/output signal distributor.

### Effect of the Invention

According to the present invention, since the parallel input/output communication data between the facility-side controller side and the semiconductor manufacturing apparatus side are outputted not only by the first output unit that outputs to the facility-side controller but also by the second output unit, for example, the signal from the second output unit may be transferred to a parallel input/output analyzing system which is separated from the facility-side controller side. As a result, when a problem occurs during the parallel input/output communication, the parallel input/output signal analyzing system may provide an objective data to clarify which system is responsible for the problem. Furthermore, even though a long time has elapsed after the problem occurs, the signal data stored in the parallel input/output signal analyzing system can be analyzed. Accordingly, since an operator does not need to confirm the contents of the parallel input/output communication in real time, there is an effect that reduces the physical and mental pains of the operator.

### BRIEF DESCRIPTION OF DRAWINGS

FIG. 1 is a view illustrating a conventional parallel input/output communication system.

FIG. 2 is a view illustrating a parallel input/output communication system according to an exemplary embodiment of the present invention.

FIG. 3 is a front view of a parallel input/output signal distributor according to an exemplary embodiment of the present invention.

FIG. 4 is a rear view of the parallel input/output signal distributor according to the exemplary embodiment of the present invention.

FIG. 5 is a circuit diagram illustrating the configuration of the parallel input/output signal distributor according to the exemplary embodiment of the present invention.

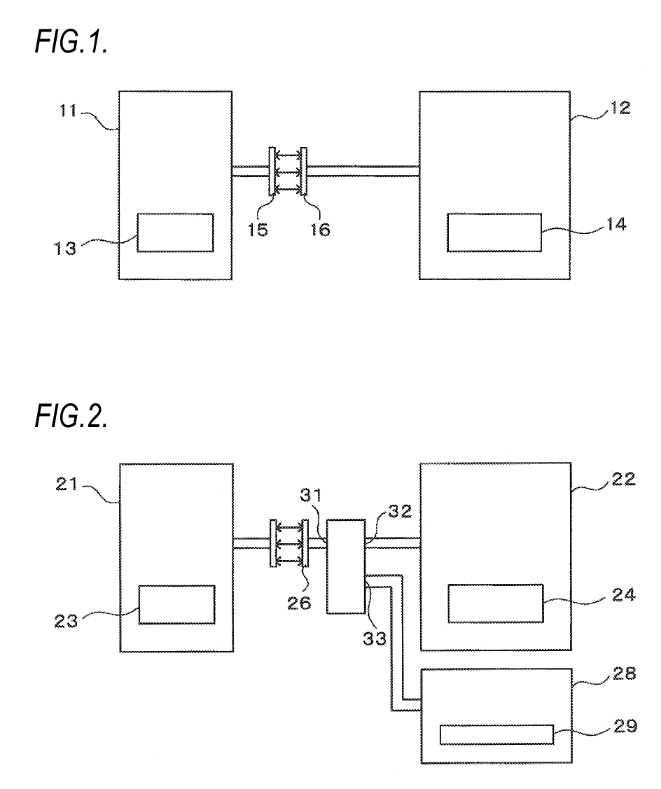

### EXPLANATION OF SYMBOLS

21 Semiconductor manufacturing apparatus
22 Facility-side controller
26 Output signal sensor end
27 Parallel input/output signal distributor
28 Parallel input/output signal analyzing system
31 Input unit
32 First output unit
33 Second output unit

### DETAILED DESCRIPTION

Hereinafter, exemplary embodiments of the present invention will be described with reference to FIGS. 2 to 5. FIG. 2 is a view illustrating a parallel input/output communication system according to a suitable exemplary embodiment of the present invention. A parallel input/output communication between a semiconductor manufacturing apparatus 21 and a facility-side controller 22 refers to a parallel input/output communication using a SECS protocol, and the SECS protocol is a data communication standard regulation defined for an interface between a semiconductor manufacturing apparatus and an outer host in an equipment automated field of a SEMI for a standardization of the related technologies. The SECS protocol is constituted by a SECS-I that defines a serial communication using a RS-232C mode, a HSMS mode that defines a TCP/IP communication, and a SECS-II that defines the contents of message service.

In the present exemplary embodiment, as illustrated in FIG. 2, a parallel input/output signal distributor 27 is disposed at a parallel input/output signal sensor end 26 side of the facility-side controller 22 side, and all the signals according to the parallel input/output communication performed between the semiconductor manufacturing apparatus 21 and the facility-side controller 22, which is inputted from the parallel input/output signal sensor end 26 of the facility-side controller 22, are outputted to the facility-side controller 22 and a parallel input/output signal analyzing system 28 provided separately from the facility-side controller 22. The parallel input/output signal used in the communication is stored as a parallel input/output communication log data 23 in the semiconductor manufacturing apparatus 21, stored as a parallel input/output communication log data 24 in the facility-side controller 22, and stored as a parallel input/output communication log data 29 in the parallel input/output signal analyzing system 28.

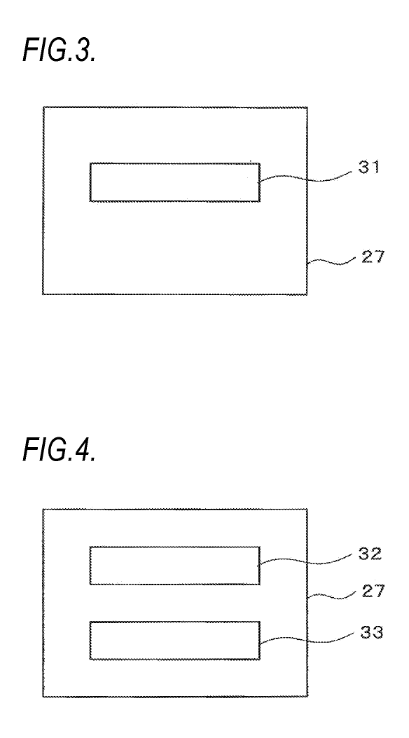

FIGS. 3 and 4 illustrate a front side and a rear side of the parallel input/output signal distributor 27 according to a suitable exemplary embodiment of the present invention. A parallel input/output signal is inputted to an input unit 31 of the parallel input/output signal distributor 27 from the parallel input/output signal sensor end 26 of the facility-side controller 22 side. A first output unit 32 of the parallel input/output signal distributor 27 provided in the opposite side (rear side) to the input unit 31 outputs the parallel input/output signal inputted by the input unit 31 to the facility-side controller 22. A second output unit 33 of the parallel input/output signal distributor 27 is provided in the same side of the first output unit 32 and outputs the parallel input/output signal inputted by the input unit 31 to the parallel input/output signal analyzing system 28.

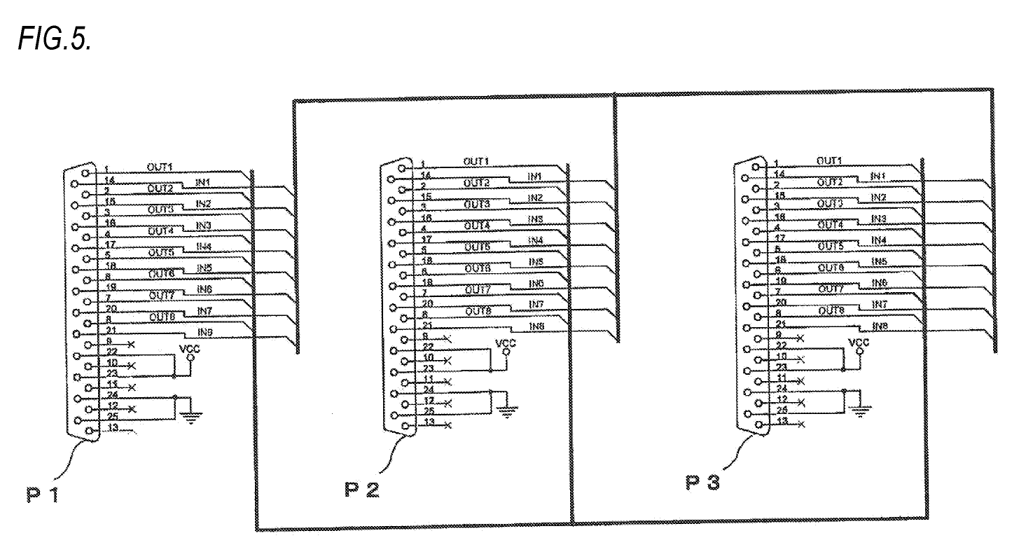

FIG. 5 illustrates a circuit diagram of the configuration of the parallel input/output signal distributor 27 according to the exemplary embodiment of the present invention. In FIG. 5, a first connector P1 with twenty five pins corresponding to the input unit 31, a second connector P2 with twenty five pins corresponding to the first output unit 32, and a third connector P3 with twenty five pins corresponding to the second output unit 33 are illustrated (In FIG. 5, each of the small-scaled numbers 1 to 25 represents a pin number). The #1 to #8 pins and #14 to #21 pins used for a transmission of a signal in the connectors P1, P2, P3 are connected to the corresponding pins having the same pin numbers, respectively. That is, the #1 pin of the first connector P1 is connected to both of the #1 pin of the second connector P2 and the #1 pin of the third connector P3, the #2 pin of the first connector P1 is connected to both of the #2 pin of the second connector P2 and the #2 pin of the third connector P3, and other pins (#3 to #8 pins and #14 to #21 pins) are similarly connected to the pins having the same pin numbers, respectively. According to the configuration, when a parallel input/output signal is inputted to the first connector P1 and is outputted from the second connector P2 and the third connector P3, a deformation of a signal does not occur, and as a result, the parallel input/output signal can be inputted/outputted as it is without generating a change in a voltage value or a current value for a signal to be transmitted.

As such, in the present exemplary embodiment, the parallel input/output signal inputted from the parallel input/output signal sensor end 26 of the facility-side controller 22 side through the input unit 31 is outputted to both of the facility-side controller 22 and the parallel input/output signal analyzing system 28 from the first output unit 32 and the second output unit 33, respectively. As a result, since the parallel input/output signal is stored not only in the facility-side controller 22 but also in the parallel input/output signal analyzing system 28 as a parallel input/output communication log data 29, when a problem occurs during the parallel input/output communication, the problem can be solved by analyzing the parallel input/output communication log data 29 stored in the parallel input/output signal analyzing system 28 in various ways.

Furthermore, it is preferable that the voltage value or the current value of the parallel input/output signal does not change when the parallel input/output signal is inputted to the input unit 31 or outputted to the facility-side controller 22 and the parallel input/output signal analyzing system 28 from the first output unit 32 and the second output unit 33. According to the configuration, since the parallel input/output signal inputted from the parallel input/output signal sensor end 26 of the facility-side controller 22 is transferred to the parallel input/output signal analyzing system 28 without being changed, the parallel input/output signal can be accurately analyzed.

The parallel input/output signal in the present invention may be stored in the facility-side controller 22 and the parallel input/output signal analyzing system 28 as logging data.

In a suitable exemplary embodiment of the parallel input/output signal distributor 27 according to the present invention, data may be collected using a maximum of 10 MHz of frequency, and, therefore, a large number of data may be collected at the same time.

In a suitable exemplary embodiment of the parallel input/output signal distributor 27 according to the present invention, a display window (e.g., an LED window) may be provided on the surface side thereof, enabling to monitor the states of the substrate and the communication in real time through the display window.

In a suitable exemplary embodiment of the parallel input/output signal distributor 27 according to the present invention, it may be possible to correspond to a serial communication using a RS-232C. In a suitable exemplary embodiment of the parallel input/output signal distributor 27 according to the present invention, it may be possible to correspond to a TCP/IP communication using a RJ-45 Ethernet port (“Ethernet” is a trademark of Xerox Corporation).

In a suitable exemplary embodiment of the parallel input/output signal distributor 27 according to the present invention, the logging data to confirm the state of the parallel input/output signal distributor 27 may be configured to be stored by 10 MB capacity at a maximum, the state of the parallel input/output signal distributor 27 itself may be confirmed from the logging data.

Next, a distribution method of the parallel input/output signal according to the present invention will be described. A parallel input/output signal by a parallel input/output communication between a semiconductor manufacturing apparatus 21 and a facility-side controller 22 is inputted to an input unit 31 of a parallel input/output signal distributor 27 from a parallel input/output signal sensor end 26 of the facility-side controller 22 side. The parallel input/output signal inputted to the input unit 31 is outputted to the facility-side controller 22 from a first output unit 32 of the parallel input/output signal distributor 27 and outputted to a parallel input/output analyzing system 28 from a second output unit 33 as well.

According to the configuration as described above, by outputting the parallel input/output signal inputted to the input unit 31 from the parallel input/output signal sensor end 26 of the facility-side controller 22 side to the corresponding facility-side controller 22 and the parallel input/output signal analyzing system 28, respectively, the parallel input/output signal is stored not only to the facility-side controller 22 but also to the parallel input/output signal analyzing system 28 as parallel input/output communication log data 29. As a result, when an abnormality occurs during the parallel input/output communication, the conventional problems can be solved by analyzing the parallel input/output communication log data 29 stored in the parallel input/output signal analyzing system 28 in various ways.

It is preferable that the voltage value or the current value of the parallel input/output signal does not change when the parallel input/output signal is outputted to the facility-side controller 22 and the parallel input/output signal analyzing system 28 from the first output unit 32 and the second output unit 33. As a result, since the parallel input/output signal inputted from the parallel input/output signal sensor end 26 of the facility-side controller 22 is transferred to the parallel input/output signal analyzing system 28 without being changed, the parallel input/output signal can be accurately analyzed.

In the parallel input/output signal distributor and the parallel input/output signal distribution method according to the present invention, the parallel input/output signal that performs a communication using the SECS protocol is stored as logging data. And in a system that monitors the automated manufacturing process from the data, the parallel input/output communication data between the facility-side controller and a semiconductor manufacturing apparatus are transferred to the parallel input/output analyzing system. Therefore, when a problem occurs during the parallel input/output communication, objective data can be provided. As a result, it is possible to clarify which system is responsible for the problem and analyze the signal data stored in the parallel input/output signal analyzing system even though a long time has elapsed after the problem occurs. Furthermore, since an operator does not need to confirm the contents of the parallel input/output communication in real time, there is an effect that reduces the physical and mental pains of the operator.

From the foregoing, it will be appreciated that various embodiments of the present invention have been described herein for purposes of illustration, and that various modifications may be made without departing from the scope and spirit of the present invention. Accordingly, the various embodiments disclosed herein are not intended to be limiting, with the true scope and spirit being indicated by the following claims.

### INDUSTRIAL APPLICABILITY

The present invention is useful for an automated facility in a semiconductor manufacturing process.

What is claimed is:

1. A parallel input/output signal distributor that distributes the contents of a parallel input/output communication between a semiconductor manufacturing apparatus and a facility-side controller of an automated facility of a semiconductor manufacturing process, the distributor comprising:
an input unit to which a parallel input/output signal including the contents of the parallel input/output communication between the facility-side controller and the semiconductor manufacturing apparatus is inputted from a parallel input/output signal sensor end of the facility-side controller side;
a first output unit configured to output the inputted parallel input/output signal to the facility-side controller; and
a second output unit configured to output the inputted parallel input/output signal.

2. The parallel input/output signal distributor of claim 1, wherein, when the parallel input/output signal is inputted to the input unit or outputted from the first and second output units, the parallel input/output signal is inputted/outputted as it is without being changed in the voltage value or the current value of the signal.

3. The parallel input/output signal distributor of claim 1, wherein the parallel input/output signal includes logging data using a SECS communication protocol.

4. A parallel input/output signal distribution method for distributing the contents of the parallel input/output communication between a semiconductor manufacturing apparatus and a facility-side controller of an automated facility of a semiconductor manufacturing process using a parallel input/output signal distributor, the method comprising:
inputting a parallel input/output signal from a parallel input/output signal sensor end of the facility-side controller side by an input unit of the parallel input/output signal distributor;
outputting the inputted parallel input/output signal from a first output unit of the parallel input/output signal distributor to the facility-side controller; and
outputting the inputted parallel input/output signal from a second output unit of the parallel input/output signal distributor.

5. The parallel input/output signal distribution method of claim 4, wherein, when the parallel input/output signal is inputted to the input unit or outputted from the first and second output units, the parallel input/output signal is inputted/outputted as it is without being changed in the voltage value or the current value of the signal.

6. The parallel input/output signal distribution method of claim 4, wherein the parallel input/output signal includes logging data caused by a SECS communication protocol.
